(19) United States
(12) Patent Application Publication
(10) Pub. No.: US 2020/0287623 A1
(43) Pub. Date: Sep. 10, 2020

(54) Methods and Apparatus for Detecting a Fault in an Optical Communication Network

(71) Applicant: TELEFONAKTIEBOLAGET LM ERICSSON (PUBL), Stockholm (SE)

(72) Inventors: Roberto MAGRI, Genoa (IT); Alberto DEHO, Genoa (IT)

(73) Assignee: Telefonaktiebolaget LM Ericsson (publ), Stockholm (SE)

(21) Appl. No.: 16/628,734

(22) PCT Filed: Jul. 12, 2017
(86) PCT No.: PCT/EP2017/067645

§ 371 Date: Jan. 6, 2020

(51) Int. Cl. H04B 10/079; H04B 10/54; H04B 10/532; H04B 10/27

(52) U.S. Cl. CPC H04B 10/079; H04B 10/27; H04B 10/532; H04B 10/54

(57) ABSTRACT

An apparatus (20) is configured as a remote unit for communication with a main unit (10) in an optical communication network (30), wherein the main unit and remote unit are configured to detect a fault in the optical communication network. The apparatus comprises a modulation converter (22;62) configured to receive a first optical signal from the main unit on the optical communication network, wherein the first optical signal has a first modulation type. The modulation converter is configured to convert the first optical signal having the first modulation type to a second optical signal having a second modulation type. The second modulation type is different to the first modulation type. The modulation converter (22;62) is a passive device. The apparatus is configured to send the second optical signal having the second modulation type to the main unit (10) using the optical communication network (30).

### TECHNICAL FIELD

The present disclosure relates to methods and apparatus for detecting a fault in an optical communication network.

### BACKGROUND

Optical communication networks are used to transport data using optical signals. An example use of an optical communication network is for a fronthaul network or fronthaul connection in a radio access network. In some examples, the radio system and fronthaul infrastructure may belong to different owners or manufacturers or developed independently. It is useful to design a demarcation point between the two domains in order to identify fault responsibilities and ease troubleshooting and maintenance operations.

Three scenarios are possible:

1) Active Fronthaul: transponders are used to color and transport a radio data (e.g. CPRI) signal over a xWDM infrastructure. In this case, there is an active transponder in both the main unit and remote unit. The transponder acts as demarcation point between radio systems and fronthaul network

2) Passive Fronthaul: no transponders are used. Colored transceivers are directly equipped on radio units and the xWDM infrastructure is pure passive network (filter, couplers, etc). With this option no demarcation point can be identified and, in case of fault, it can be difficult to find domain responsibility to activate service level agreements (SLAs) and proper countermeasures. It may be difficult, for example, to understand if an out-of-service condition is a consequence of a fiber break or a power failure in the radio units.

3) Semi-Passive Fronthaul: a combination of passive fronthaul with an added active subsystem, for example only in the main site to implement monitoring features to provide fault isolation.

Semi-Passive Fronthaul may offer a suitable trade-off between cost and monitoring/demarcation capabilities. However, current solutions to demarcate a fiber fault have some limitations, for example, are expensive or are not applicable to a single-fiber working operation. Some solutions may not be self-confined and so not suitable for semi-passive fronthaul, or may not be robust and reliable.

In a known solution using double fiber infrastructure, a self-confined technique to monitor a fiber fault in the fronthaul network is to insert a monitoring wavelength in the main site and loop it back at the remote site. The fiber fault is detected by monitoring the received power back at the main site. This can be easily implemented in semi-passive scenario but does not work in a single fiber operation since the fiber break would create a reflection of the monitoring wavelength that would be detected even if continuity is lost. This is a known problem in single fiber operation

WO2017/016592 describes a tone-marker in the downstream signal to identify the reflected power with respect to upstream signal. However, this may require a strong reflection after a break.

WO2017/071827 is based on a protected scheme, and is not applicable on single fiber un-protected links.

An optical time-domain reflectometer (OTDR) may be used to characterize an optical fiber. However, such OTDR instruments may be relatively expensive.

A further known solution involves monitoring power from transceivers at the remote units. This is not a self-confined approach and is not able to discriminate between fiber and equipment fault.

H. Fathallah, L. A. Rusch, “Network management solution for PS/PON WDM/PON and hybrid PS/WDM/PON using DSOCDM”, Proc. OFC/NFOEC, pp. 1-3, 2007-March describes a pulse train being sent at the main site, and a passive optical encoder at the remote site. The encoder is based on delay lines and reflectors in order to transform the pulse train in a coded pulse sequence that is reflected back to the main site. At the main site the encoded sequence is detected. Delay lines are not simple to implement and the active device requires sophisticated digital logic.

An effective solution to detecting a fault in an optical communications network is therefore required.

### SUMMARY

According to a first aspect of the present disclosure, there is provided an apparatus is configured as a remote unit for communication with a main unit in an optical communication network, wherein the main unit and remote unit are configured to detect a fault in the optical communication network. The apparatus comprises a modulation converter configured to receive a first optical signal from the main unit on the optical communication network, wherein the first optical signal has a first modulation type. The modulation converter is configured to convert the first optical signal having the first modulation type to a second optical signal having a second modulation type. The second modulation type is different to the first modulation type. The modulation converter is a passive device. The apparatus is configured to send the second optical signal having the second modulation type to the main unit using the optical communication network.

Optionally, the modulation converter has a transfer function configured such that the variations of the first optical signal corresponding to the first modulation type correspond to variations in the second modulation type.

Optionally, the transfer function continuously varies in a range of the first modulation type of the first optical signal.

Optionally, the modulation converter is a filter configured to modulation convert the first optical signal, and wherein the first modulation type is a wavelength modulation, or, wherein the modulation converter is a polarizer configured to modulation convert the first optical signal, and wherein the first modulation type is a polarization modulation.

Optionally, the apparatus comprises a reflector configured to reflect the first or second optical signal towards the main unit.

Optionally, the apparatus is configured to pass optical frequencies outside of a band of the first and second optical signals.

According to a second aspect of the present disclosure, there is provided an apparatus configured as a main unit for communication with a remote unit in an optical communication network. The main unit and remote unit are configured to detect a fault in the optical communication network. The apparatus comprises a transmitter configured to transmit a first optical signal from the main unit on the optical communication network. The first optical signal has a first modulation type. A receiver is configured to receive from the remote unit a second optical signal having a second modulation type on the optical communication network, wherein the second modulation type is different to the first modulation type. A detector is configured to identify a presence of the second optical signal to detect a fault in the optical communication network.

Optionally, the detector is configured to identify periodic variations in the second optical signal corresponding to the second modulation type.

Optionally, the first modulation type is a wavelength modulation or a polarization modulation.

Optionally, the second modulation type is an intensity modulation.

Optionally, optical communication network is a single bidirectional optical fiber connecting the main unit and remote unit.

Optionally, the remote unit is connected to a remote radio unit and/or the main unit is connected to a baseband processing unit.

Optionally, the first and second optical signals are in a frequency range which is out of band of data transmitted on the optical communications network.

According to a third aspect of the present disclosure, there is provided a system comprising a remote unit and a main unit. The remote unit is configured for communication with the main unit in an optical communication network. The main unit and remote unit are configured to detect a fault in the optical communication network. The main unit comprises a transmitter configured to transmit a first optical signal from the main unit on the optical communication network, wherein the first optical signal has a first modulation type. A receiver is configured to receive from the remote unit a second optical signal having a second modulation type on the optical communication network, wherein the second modulation type is different to the first modulation type. A detector is configured to identify a presence of second optical signal to detect a fault in the optical communication network. The remote unit comprises a modulation converter configured to receive the first optical signal from the main unit on the optical communication network, wherein the modulation converter is configured to convert the first optical signal having the first modulation type to the second optical signal having a second modulation type. The modulation converter is a passive device, and the apparatus is configured to send the second optical signal having the second modulation type to the main unit using the optical communication network.

According to a fourth aspect of the present disclosure, there is provided a method in a remote unit for communicating with a main unit in an optical communication network, wherein the main unit and remote unit are detecting a fault in the optical communication network. The method comprises modulation converting a first optical signal received from the main unit on the optical communication network, wherein the first optical signal has a first modulation type. The modulation converter converts the first optical signal having the first modulation type to a second optical signal having a second modulation type, wherein the second modulation type is different to the first modulation type. The modulation converting uses a passive device, and sending the second optical signal having the second modulation type to the main unit using the optical communication network.

Optionally, the modulation converting is by a filter configured to modulation convert the first optical signal, and wherein the first modulation type is a wavelength modulation, or, wherein the modulation converting is by a polarizer configured to modulation convert the first optical signal, and wherein the first modulation type is a polarization modulation.

Optionally, the method comprises reflecting the first or second optical signal towards the main unit.

According to a fifth aspect of the present disclosure, there is provided a method in a main unit for communicating with a remote unit in an optical communication network, wherein the main unit and remote unit are detecting a fault in the optical communication network. The method comprises transmitting a first optical signal from the main unit on the optical communication network, wherein the first optical signal has a first modulation type, receiving from the remote unit an optical signal, and identifying a presence of a second optical signal in the received optical signal to detect a fault in the optical communication network. The second optical signal having a second modulation type on the optical communication network, wherein the second modulation type is different to the first modulation type.

Optionally, identifying the presence of the second optical signal comprises identifying periodic variations in the second optical signal corresponding to the second modulation type.

Optionally, the first modulation type is a wavelength modulation or a polarization modulation, and/or, wherein the second modulation type is an intensity modulation.

According to a sixth aspect of the present disclosure, there is provided an apparatus configured as a main unit for communication with a remote unit in an optical communication network, wherein the main unit and remote unit are configured to detect a fault in the optical communication network. The main unit comprising processing circuitry, the processing circuitry being configured to cause the main unit to transmit a first optical signal from the main unit on the optical communication network, wherein the first optical signal has a first modulation type, receive from the remote unit an optical signal, and identify a presence of a second optical signal in the received optical signal to detect a fault in the optical communication network; the second optical signal having a second modulation type on the optical communication network. The second modulation type is different to the first modulation type.

According to a seventh aspect of the present disclosure, there is provided a computer program for detecting a fault in an optical communication network, the computer program comprising computer code which, when run on processing circuitry of a main unit in communication with a remote unit in the optical communication network, causes the main unit to transmit a first optical signal from the main unit on the optical communication network, wherein the first optical signal has a first modulation type received from the remote unit an optical signal, and identify a presence of a second optical signal in the received optical signal to detect a fault in the optical communication network; the second optical signal having a second modulation type on the optical communication network, wherein the second modulation type is different to the first modulation type.

According to an eighth aspect of the present disclosure, there is provided a computer program product comprising a computer program as claimed in any example, and a computer readable storage medium on which the computer program is stored.

### BRIEF DESCRIPTION OF THE DRAWINGS

For a better understanding of the present disclosure, and to show more clearly how it may be carried into effect, reference will now be made, by way of example, to the following drawings in which:

FIG. 1 shows a schematic diagram of apparatus according to examples of the disclosure;

FIG. 2 shows a further schematic diagram of apparatus according to examples of the disclosure;

FIG. 3 shows a further schematic diagram of a main unit according to examples of the disclosure;

FIG. 4 shows an example of a first optical signal according to examples of the disclosure;

FIG. 5 shows a schematic diagram of a remote unit according to examples of the disclosure;

FIG. 6 shows a further schematic diagram of a remote unit according to examples of the disclosure;

FIG. 7 shows an example transfer function according to examples of the disclosure;

FIG. 8 shows an example of a second optical signal according to examples of the disclosure;

FIG. 9 shows a further example of a first optical signal according to examples of the disclosure;

FIG. 10 shows a further example of a remote unit according to examples of the disclosure;

FIG. 11 shows a further example transfer function according to examples of the disclosure;

FIG. 12 shows an example of a first and second optical signal according to examples of the disclosure;

FIG. 13 shows an example method at the main unit;

FIG. 14 shows an example method at the remote unit; and

FIG. 15 shows an example method at the main unit and remote unit.

### DETAILED DESCRIPTION

Aspects of the disclosure provide apparatus to detect a fault in an optical communication network. The apparatus is suitable for use with a single optical fiber providing bidirectional communication, i.e. the optical communication network is a single optical fiber providing bidirectional communication. The apparatus may be used to detect faults between a main unit and a remote unit in a radio access network, in particular, carrying radio data between a baseband processing unit and a remote radio unit. The apparatus uses only passive components at the remote unit, e.g. connected to the remote radio unit.

In some aspects, the apparatus and method apply a modulation (e.g. wavelength or polarization) to an optical source at the main site and apply a passive modulation conversion from the applied modulation to a different type of modulation, e.g. an intensity modulation at the remote site which is reflected back to the main site. The intensity modulation is checked at the main site to verify the fiber continuity. This effectively provides an indication of a fault in the optical communication network to the main unit.

The method and apparatus described detect an optical fiber fault. The method uses low cost components and is suited for short distances, for example in fronthaul networks or small cell radio access networks. In these networks, the described solution provides an indication of whether the radio equipment (e.g. remote radio unit) or the optical communication network is causing a fault, providing for fault domain demarcation. In some examples, the optical communication network on which the described apparatus is arranged to detect a fault is a point-to-point optical link.

The modulation (e.g. wavelength or polarization) of the monitoring first optical signal can be a low frequency tone or dither. In this way, the converted intensity modulation can be easily detected at the main site with an analog or digital narrow filter.

The wavelength or polarization to intensity conversion ‘marks’ the probing signal as a proof that the probing signal reached the remote end of the fiber (the demarcation point). If the converted modulation is not detected, then the one or more fiber is determined to be broken.

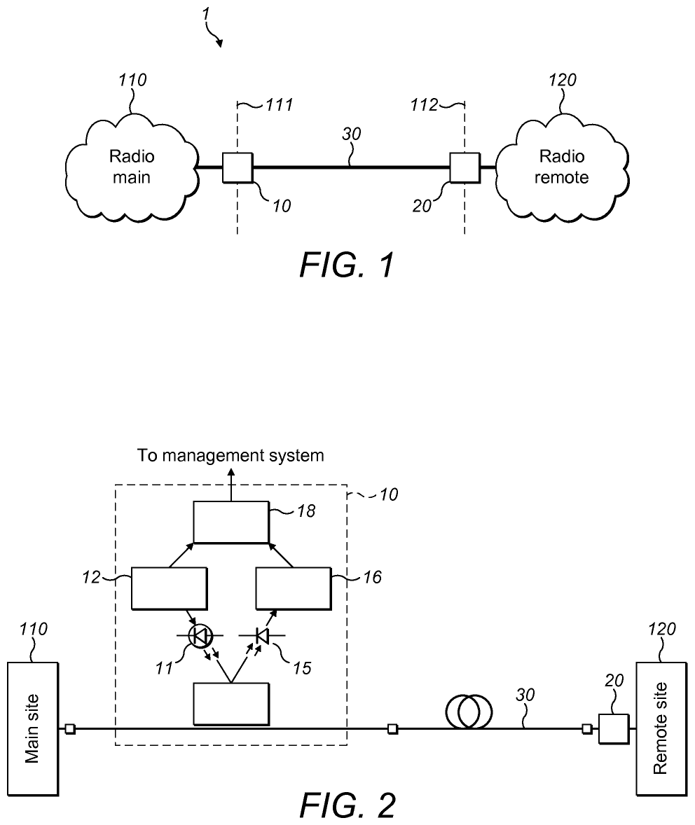

FIG. 1 shows a system 1 according to an example of the present disclosure. The system 1 comprises an apparatus configured as a main unit 10 (referred to as the main unit) and an apparatus configured as a remote unit 20 (referred to as the remote unit). The main unit 10 and remote unit 20 are in communication over an optical communication network 30, e.g. using an optical fiber. In some examples, the optical communication network 30 is a point-to-point link.

In this example, the main unit 10 is adjacent to, or a part of, a radio main unit 110. The radio main unit 110 may provide for baseband processing of radio data, and may alternatively be known as a baseband processing unit or digital unit. The remote unit 20 is adjacent to, or a part of, a remote radio unit 120. The remote radio unit 120 may also be referred to as the remote site. The remote radio unit is configured to convert the radio data into a format for transmission by an antenna (not shown). The radio main unit 110 and remote radio unit 120 may be considered to form a radio base station. The main unit 10 and remote unit 20 may be considered be part of a radio access network, e.g. for providing wireless cellular coverage to wireless devices (e.g. User Equipment, UEs). In some aspects, the remote radio unit 120 provides a small cell (e.g. micro or pico cell). Alternatively, the remote radio unit 120 provides a macro cell.

The radio main unit 110 and remote radio unit 120 are connected by a fronthaul network, i.e. the optical communication network 30. The optical communication network 30 provides for radio data to be transported between one or more remote radio unit 120 and the radio main unit 110. In some examples, the radio data is digitized, e.g. in the form of a CPRI signal. The optical communication network 30 may be provided by a single-fiber providing bidirectional operation. Thus, optical signals in each direction between the main unit 10 and remote unit 20 uses the same single fiber. For this type of optical network, the present disclosure provides for differentiating between reflections from a fiber break (i.e. a fault in the optical communication network 30) and reflections from the remote unit (i.e. no fault in the optical communication network 30).

The main unit 10 and remote unit 20 are located at what may be considered as boundaries 111,112 between the optical communication network 30 and the radio domain (radio main unit 110 and remote radio unit 120). Therefore, determination of a fault (or no fault) by the main unit 10 and remote unit 20 provides for identification of whether the fault is within the optical communication network 30 or outside of the optical communication network 30, e.g. in the equipment of the radio main unit 110 and remote radio unit 120.

The main unit 10 is configured to generate a probing optical signal, referred to as the first optical signal, in order to detect a fault. The first optical signal has a modulation of a first parameter, i.e. a first modulation type. For example, the first parameter may be a physical parameter, e.g. a wavelength or a polarization of the first optical signal, i.e. the first modulation type may be a wavelength modulation or a polarization modulation. As such, the first parameter of the first optical signal varies with time.

FIG. 2 shows functional units or subsystems of the main unit 10.

The main unit comprises an optical source 11, e.g. a laser, optionally controlled by a driver 12. The light generated by the optical source 11 is transmitted through a separate or integral modulator (not shown) to provide the first optical signal. The modulation may be generated by any suitable method. For example, the first optical signal may be a wavelength or polarization dithering. The modulation may be considered as a tone modulation. In some examples, the first optical signal, or monitoring wavelength, is a low frequency modulation, e.g. wavelength. In some examples, the modulation of the first optical signal is obtained by a thermal control.

The wavelength used by the first optical signal is in a different wavelength band than used for data (e.g. radio data) transmission on the optical communication network 30. Thus, the first optical signal may be considered as an out-of-band optical signal. The first optical signal is transmitted without any modulation used for a second optical signal, as will be described below. For example, the first optical signal is transmitted with a substantially constant intensity.

The main unit 10 further comprises a monitoring subsystem comprising a receiver 15 and a detector 16. The receiver 15 is configured to receive a second optical signal received from the remote unit 20. The receiver 15 may be implemented by a photodiode. The receiver 15 is configured to convert the received second optical signal to an electronic signal, for processing by the detector 16.

For example, the detector 16 may be configured to detect a second physical parameter of the second optical signal, e.g. intensity if the second optical signal is intensity modulated. As such, the intensity of the second optical signal varies with time. The first physical parameter is different to the second physical parameter. The detector is configured to detect the intensity modulation, e.g. using a digital filter with a level threshold.

In some examples, the detector 16 is configured to analyze the determined value of the second physical parameter, a value determined from second physical parameter, in order to identify whether there is a fault in the optical communication network 30. For example, the detector 16 is configured to compare the determined value to a threshold value. For the second physical parameter being intensity, an intensity modulation value below the threshold may indicate that the second optical signal has not been intensity modulated, indicating a fault in the optical communication network 30.

The optical driver 12 and detector 16 may be controlled by a controller 18. The controller 18 is configured to control the generation of the first optical signal. The controller 18 is further configured to receive the determination of the detector 16. The controller 18 is in communication with a management system, for example, to transmit an indication that a fault has been detected and/or to receive an instruction to initiate or control the monitoring.

In some examples, the main unit 10 comprises a coupler 19. The coupler 19 is configured to couple the optical source 11 and receiver 15 to the optical communication network 30, e.g. single fiber.

The main unit 10 is an active apparatus or subsystem. In particular, the main unit 10 comprises active components 11,12,15,16,18 e.g. for generating the modulated first optical signal and for receiving and detecting the returned second optical signal.

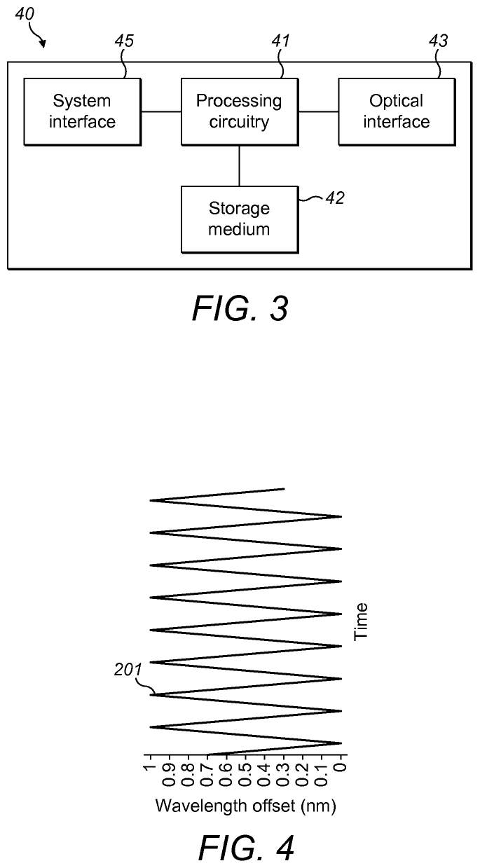

FIG. 3 shows a functional representation of a main unit 40, corresponding to the main unit 10. The main unit 40 is configured to carry out the functions described above for the main unit 10. The main unit 40 comprises processing circuitry 41, connected to a storage medium 42.

An optical interface 43 is configured to generate and receive optical signals, corresponding to the optical source 11 and receiver 15 described above. The optical interface 43 is controlled by the processing circuitry 41.

The main unit 40 further comprises a system interface 45, configured to provide for communication with a management system or other external entity.

The processing circuitry 41, which may alternatively be considered as one or more processor, is provided using any combination of one or more of a suitable central processing unit (CPU), multiprocessor, microcontroller, digital signal processor (DSP), etc., capable of executing software instructions stored in a computer program product, e.g. in the form of a storage medium 42. The processing circuitry 41 may further be provided as at least one application specific integrated circuit (ASIC), or field programmable gate array (FPGA).

In some examples, the processing circuitry 41 is configured to cause the main unit 40 to perform a set of operations, or steps, as described. For example, the storage medium 42 may store the set of operations, and the processing circuitry 41 may be configured to retrieve the set of operations from the storage medium 42 to cause the main unit 40 to perform the set of operations. The set of operations may be provided as a set of executable instructions. Thus the processing circuitry 41 is thereby arranged to execute methods as herein disclosed in any example.

The storage medium 42 may comprise temporary or persistent storage, which, for example, can be any single one or combination of magnetic memory, optical memory, solid state memory or remotely mounted memory.

The system interface 45 provides for communications with another system, as part of the same or different network node. As such, the communications interface 45 may comprise one or more transmitters and receivers, comprising analogue and digital components and a suitable number of antennas for wireless communications and/or ports for wireline communications.

The processing circuitry 41 controls the general operation of the main unit 40 by sending control signals and/or data to the optical interface 43, system interface 45 and the storage medium 42, by receiving data and reports from the optical interface 43 and system interface 45, and by retrieving data and instructions from the storage medium 42. Other components, as well as the related functionality, of the main unit 40 are omitted in order not to obscure the concepts presented herein.

The main unit 10,40 may be provided as a standalone device or as a part of at least one further device. For example, the main unit 10,40 may be provided in a node of the radio access network or in a node of the core network. For example, the main unit 10,40, or at least its functionality, could be implemented in a radio base station, a base transceiver station, a NodeBs, an evolved NodeBs, gNB, an access point, or an access node. Alternatively, functionality of the main unit may be distributed between at least two devices, or nodes. These at least two nodes, or devices, may either be part of the same network part (such as the radio access network) or may be spread between at least two such network devices, parts or nodes. In general terms, instructions that are required to be performed in real time may be performed in one or more device, or node, in the radio access network.

Thus, a first portion of the instructions performed by the main unit 10,40 may be executed in a first device, and a second portion of the of the instructions performed by the main unit 10,40 may be executed in a second device; the herein disclosed embodiments are not limited to any particular number of devices on which the instructions performed by the main unit 10,40 may be executed. Hence, the methods according to the herein disclosed embodiments are suitable to be performed by a main unit 10,40 residing in a cloud computational environment. Therefore, although a single processing circuitry 41 is illustrated, the processing circuitry 41 may be distributed among a plurality of devices, or nodes. The same applies to the functional units described above.

FIG. 4 shows an example of the first modulation type of the first optical signal. The first physical parameter which is modulated is the wavelength. As shown, the wavelength 201 varies with time, e.g. as a wavelength dithering. The first optical signal does not encode data as such. The first optical signal varies in wavelength linearly with time between a maximum wavelength and a minimum wavelength. Any form or shape of waveform may be used, e.g. any pattern of variation of wavelength over time.

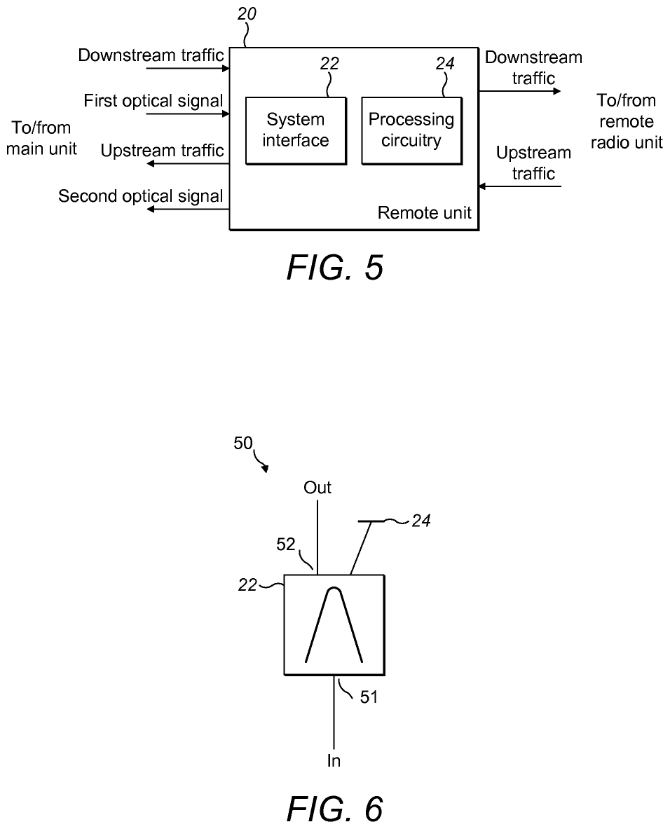

FIG. 5 shows a functional representation of the remote unit 20 and associated input and output optical signals to/from the main unit and remote site.

The remote unit 20 comprises a modulation converter 22 and a reflector 24. The modulation converter 22 and reflector 24 may be considered as a selective reflector.

The modulation converter 22 and reflector 24 are configured to receive the first optical signal from the main unit, convert the modulation to a different type of modulation (i.e. a different physical parameter is modulated) and transmit the modulation converted optical signal back towards the main unit. The modulation converter 22 and reflector 24 are passive components. Thus, the modulation converter 22 and reflector 24 do not require a power source or control signals in order to operate. In examples, the modulation converter 22 is implemented by a filter or a polarizer, as described in detail below. The reflector 24 sends the second optical signal towards the main unit without a power source, i.e. remote unit does not use an optical source (e.g. laser) for the second optical signal.

The remote unit 20 is configured to allow downstream traffic, i.e. comprising data, to pass through the remote unit 20 substantially without alteration. Similarly, the remote unit 20 is configured to allow upstream traffic, i.e. comprising data, to pass through the remote unit 20 substantially without alteration. The upstream and downstream traffic may comprise radio data transmitted between the radio main unit 110 and remote radio unit 120.

In a first example, the first optical signal comprises a wavelength modulation. The remote unit 20 is configured to passively generate a second optical signal from the first optical signal, and transmit the second optical signal to the main unit 10. The second optical signal is intensity modulated. The modulation converter 22 is implemented by a filter 22.

In some aspects, the filter 22 in the remote unit provides an isolation between the pass band and the rejection band which is high enough to produce a good wavelength to amplitude conversion. An example figure is 30 dB.

Examples of the remote unit may be integrated in a fiber patchchord to simplify installation, e.g. at or adjacent to the remote radio unit.

FIG. 6 shows a further example of a remote unit 50. The remote unit 50 comprises a modulation converter 22 and a reflector 24, as described above for the remote unit 20. The filter 22 receives the first optical signal from the main unit at an input port 51. The filter 22 outputs at least the data traffic from an output port 52 to the radio remote unit 120. The optical signal passing through the output port 52 may or may not include the first optical signal. The filter 22 is further configured to pass at least the first optical signal, modulation converted to the second optical signal, to the reflector 24. The reflector 24 is arranged to reflect the second optical signal back towards the main unit. This representation of the filter 22 and reflector 24 may be considered as functional, and actual implementation may combine these functions into one or more passive components. For example, the filter 22 and reflector 24 may be provided together by a reflection filter, e.g. a thin-film filter.

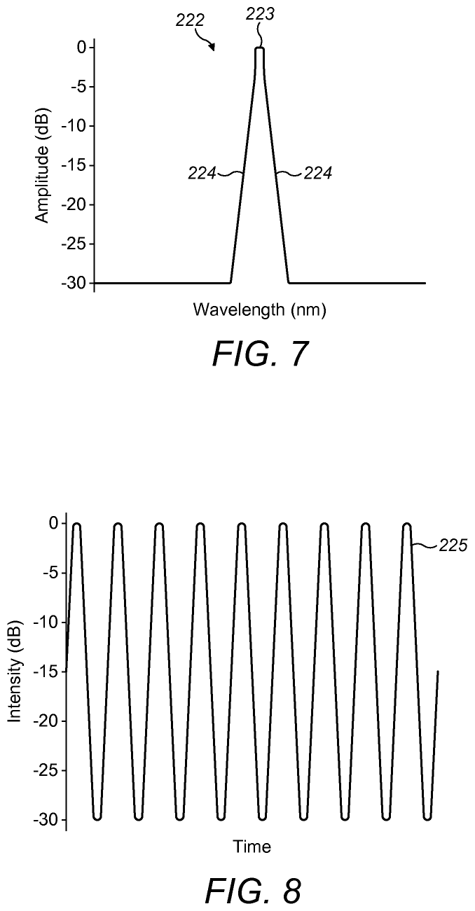

FIG. 7 shows an example of a transfer function 222 of the modulation converter 22, showing a response of the modulation converter 22 using a filter. The response of the filter 22 is shown against wavelength. The response is an amplitude, or intensity, of the optical signal which is used for the second optical signal, either from a transmission or reflection of the filter 22. The transfer function of the filter may also be referred to as a filter characteristic or frequency response.

In this example, the transfer function 222 has a peak 223 at a pre-determined central wavelength, corresponding to a maximum amplitude for the second optical signal. For wavelengths away from the central wavelength, the intensity of the optical signal output by the filter 22 reduces. The further the wavelength from the central wavelength, the more the output intensity reduces. In the example shown, the decrease in output intensity, or roll-off 224, varies linearly with wavelength. The slope of the roll-off 224 is uniform with wavelength, and has an equal magnitude on both side of the central wavelength. Other transfer function shapes may be used, i.e. a linear response away from the central wavelength is not required.

Generally, the filter 22 provides an intensity output which is dependent on, or varies with the physical parameter with which the first optical signal is modulated, e.g. wavelength. For example, the roll-off 224 may have a slope which is non-linear. In this example, the transfer function is a continuous function of wavelength. In some aspects, intensity values which are intermediate a maximum intensity and a minimum intensity are used for the second optical signal, e.g. the intensity values which are intermediate a maximum intensity and a minimum intensity are used for the second optical signal for a majority of the second optical signal. In other examples, the transfer function may comprise a step function, in which the variations in the first physical parameter (e.g. wavelength) vary the output of the filter substantially between a maximum and a minimum intensity value (not shown).

In some aspects, this modulation conversion is the result of the transfer function of the filter 22 being centered within the monitoring wavelength modulation swing. With a good isolation of the filter 22, a high contrast amplitude modulation may be obtained. In some examples, the amplitude passband 224 is confined within the laser wavelength modulation swing. Thus, a wavelength to intensity conversion is always produced. In some aspects, the amplitude passband 224 is greater in frequency extent than variation in frequency of the first optical signal caused by the wavelength modulation.

In some aspects, the modulation converter has a transfer function 222 configured such that the variations of the first optical signal corresponding to the first modulation type (e.g. wavelength) correspond to variations in the second modulation type (e.g. intensity). In some aspects, the transfer function 222 continuously varies in a range (i.e. swing) of the first modulation type of the first optical signal.

In some aspects, the selective filter 22 can be either a CWDM filter or a DWDM filter. A CWDM filter has a wider bandwidth and requires a larger swing on the wavelength modulation. The swing may be considered as the variation in wavelength over time, e.g. minimum and a maximum wavelength within which the wavelength varies in the first optical signal. An out-of-band DWDM filter allows for a narrow swing if coupled with a DWDM monitoring source.

The wavelength modulation of the first optical signal may be considered to have a frequency, i.e. a frequency at which the wavelength regularly oscillates between a maximum and minimum wavelength. The modulation frequency is independent and a separate concept to the actual central wavelength or wavelength band used for the first optical signal. The modulation frequency applied to the optical source may be in the range of 1 to 10 Hz. The modulation frequency may be set at manufacture of the main unit and not changed, or may be configured and changed during use. The main unit may be pre-configured or configured with a modulation frequency selected according to one or more of the following considerations:
The lower the frequency, the longer the measurement time (i.e. the detector needs to wait a given number of cycles for a reliable measurement).
The lower the frequency, the higher signal to noise ratio is achievable with narrow filtering at the detector
Low frequencies can be achieved with simple and low cost thermal control.

FIG. 8 illustrates an example intensity 225 of the second optical signal over time, based on the first optical signal shown in FIG. 4 and the filter transfer function shown in FIG. 6. The second optical signal has an intensity modulation, i.e. the intensity varies with time. The intensity modulation is due to the transfer function of the modulation converter 22 receiving the first optical signal. In this example, the intensity modulation is a linearly varying sawtooth waveform. The intensity modulation 225 has intensity maxima at a frequency (i.e. spaced in time) corresponding to twice the frequency of the wavelength modulation of the first optical signal.

The reflector 24 is arranged to reflect the modulated waveform of the second optical signal back to the main site, where the intensity modulation can be detected. The reflector may be a separate component to the filter 24, and may reflect either the modulated second optical signal to the main site or reflect the first optical signal onto the modulation converter 22 prior to passing towards the main site. In some examples, the reflector 24 is integral with the modulation converter 22, e.g. a reflection filter. In some aspects, the remote unit 20 comprises any combination or arrangement of passive components configured to convert the modulation of the first optical signal to a different type of modulation and pass the modulated second optical signal back to the main unit.

The modulation converter and/or reflector are arranged to operate only on the first optical signal, i.e. not on the data traffic. Thus, the wavelengths carrying data traffic is not modulation converted or reflected. In some examples, the first and second optical signals are in a different frequency band (i.e. out-of-band) to the wavelengths carrying data traffic.

The modulation conversion carried out by the remote unit 20 effectively ‘marks’ the first optical signal, testifying that the first optical signal reached the remote unit 20, located as a demarcation point. Thus, the presence or absence of the different type of modulation on the reflected second optical signal indicates whether or not the first optical signal was reflected by the remote unit. A reflected signal which does not contain the second optical signal is considered to be a reflection from a fiber break or other fault in the optical communication network 30.

In a second example, the first optical signal comprises a polarization modulation. As such, a polarization of the first optical signal varies over time (e.g. a linear plane of polarization varies over time). The remote unit 20 is configured to passively generate a second optical signal from the first optical signal, and transmit the second optical signal to the main unit 10. The second optical signal is intensity modulated. FIG. 5 is also applicable to this second example, as described above. The modulation converter 22 is implemented by a polarizer for the case where the first optical signal is polarization modulated.

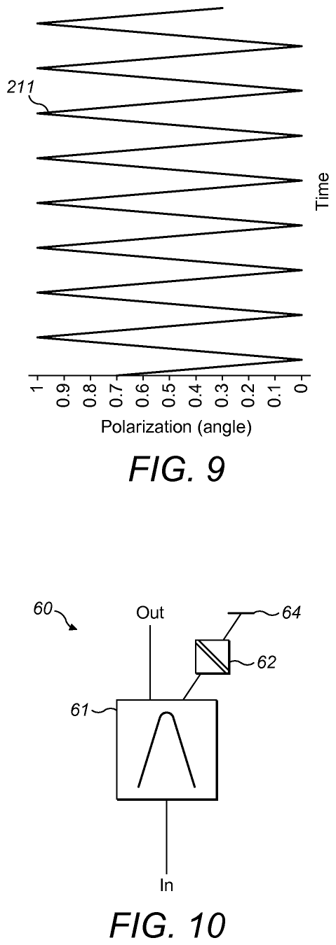

FIG. 9 shows an example of the first modulation type of the first optical signal. The first physical parameter which is modulated is the polarization. As shown, the polarization 211, e.g. polarization angle, varies with time, e.g. as a dithering. The first optical signal does not encode data as such. The first optical signal varies in polarization with time between a maximum polarization and a minimum polarization, or in some examples, rotates continuously. For example, an angle of polarization of a linearly polarized first optical signal varies in angle, e.g. between a maximum polarization and a minimum polarization or continuously, i.e. repeatedly around 360 degrees. Any form or shape of waveform may be used, e.g. any pattern of variation of polarization over time.

In some examples, the main unit is configured to apply a polarization modulation (or periodic rotation) to generate the optical monitoring signal (i.e. first optical signal). The polarization to intensity conversion is realized at the remote unit by means of a passive polarizer which acts as the demarcation point for fault isolation, as described below.

The modulation of the first optical signal, e.g. polarization, may be obtained by any method known in the art; for example: a laser followed by a polarization rotator (e.g. a squeezer) controlled by a proper driver to generate a low-frequency polarization rotation, or, two orthogonally polarized lasers whose intensity is modulated by 90-degrees phase shifted tones and then recombined.

FIG. 10 shows a further example of a remote unit 60. The remote unit 60 comprises a filter 61, modulation converter 62 and a reflector 64. In this example, the modulation converter 62 is a polarizer.

The filter 61 is configured to select the frequency band of the first optical signal, for example, in order to that the modulation conversion applied using the polarizer is applied only to the first optical signal and not to the data traffic in different frequency bands. In contrast to the filter 22 of the remote unit 50, the filter 61 does not function to convert the modulation. The filter 61 may be a passband filter, having a passband for the first optical signal which is substantially constant over the frequency band of the first optical signal.

The reflector 64 functions in a corresponding manner to the reflector 24 described above. In some aspects, the reflector 64 is arranged to reflect the modulated waveform of the second optical signal back to the main site, where the intensity modulation can be detected. The reflector may be a separate component to the polarizer 62 and/or filter 61, and may reflect either the modulated second optical signal to the main site or reflect the first optical signal onto the polarizer 62 prior to passing towards the main site. In some examples, the reflector 64 is integral with the polarizer 62 and/or filter 61, e.g. a reflection polarizer. In some aspects, the remote unit 60 comprises any combination or arrangement of passive components configured to convert the polarization of the first optical signal to a different type of modulation and pass the modulated second optical signal back to the main unit.

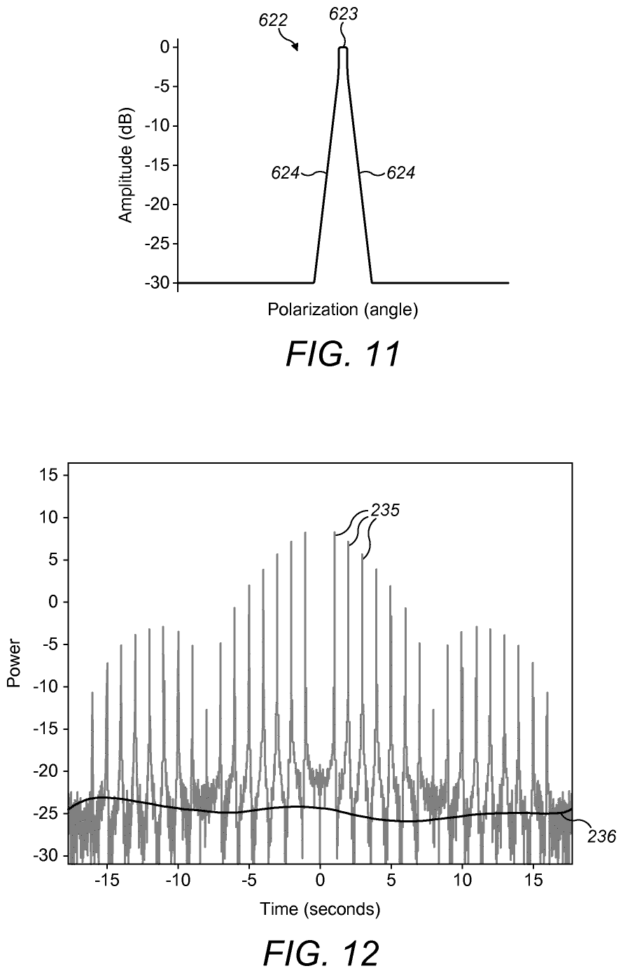

FIG. 11 shows an example transfer function 622 of the polarizer 62. The polarizer 62 has a transfer function similar to the filter 22 used for modulation conversion from a wavelength polarized first optical signal. In particular, the polarizer 62 is absorbing (or not outputting) polarizations away from one or more central polarization, so the intensity changes based on the received polarization. The response of the polarizer 62 is shown against polarization, e.g. polarization angle. The response is an amplitude, or intensity, of the optical signal which is used for the second optical signal, either from a transmission or reflection of the polarizer 62. The transfer function of the polarizer 62 may also be referred to as a polarizer characteristic or polarization response.

In this example, the transfer function 622 has a peak 623 at a pre-determined central polarization angle, corresponding to a maximum amplitude for the second optical signal. For polarization angles away from the central polarization, the intensity of the optical signal output by the polarizer 62 reduces. The further the polarization angle from the central wavelength, the more the output intensity reduces. In the example shown, the decrease in output intensity, or roll-off 624, varies linearly with polarization angle. The slope of the roll-off 624 is uniform with polarization angle, and has an equal magnitude on both side of the central polarization angle. Other transfer function shapes may be used, i.e. a linear response away from the central polarization angle is not required.

Generally, the polarizer 62 provides an intensity output which is dependent on, or varies with the physical parameter with which the first optical signal is modulated, e.g. polarization. For example, the roll-off 624 may have a slope which is non-linear. In this example, the transfer function is a continuous function of wavelength. In some aspects, intensity values which are intermediate a maximum intensity and a minimum intensity are used for the second optical signal, e.g. the intensity values which are intermediate a maximum intensity and a minimum intensity are used for the second optical signal for a majority of the second optical signal. In other examples, the transfer function may comprise a step function, in which the variations in the first physical parameter (e.g. polarization) vary the output of the polarizer substantially between a maximum and a minimum intensity value (not shown).

In some aspects, the modulation converter has a transfer function 622 configured such that the variations of the first optical signal corresponding to the first modulation type (e.g. polarization) correspond to variations in the second modulation type (e.g. intensity). In some aspects, the transfer function 622 continuously varies in a range (i.e. swing) of the first modulation type of the first optical signal.

The filter 61 is configured to select the frequency band of the first optical signal, for example, in order that the modulation conversion applied using the polarizer is applied only to the first optical signal and not to the data traffic in different frequency bands.

The remote unit 60 is configured to receive the first optical signal from the main unit at an input port 65. The filter 61 outputs at least the data traffic from an output port 66 to the radio remote unit 120. The optical signal passing through the output port 66 may or may not include the first optical signal. The filter 61 is further configured to pass at least the first optical signal, modulation converted to the second optical signal, to the polarizer 62 and reflector 64. The reflector 64 is arranged to reflect the second optical signal back towards the main unit.

FIG. 8 also illustrates an example intensity 225 of the second optical signal over time, for the example in which the first physical parameter is the polarization. The intensity 225 of the second optical signal over time is based on the first optical signal shown in FIG. 4 and the polarizer transfer function shown in FIG. 10.

FIG. 12 shows an example of a power spectrum of the second optical signal as detected by the detector 16. In some examples, the information representing the second optical signal is analyzed by the controller to determine if the second optical signal has been modulation converted.

FIG. 12 shows both a second optical signal 235 (which has been modulation converted) and a reflected first optical signal 236 (which has not been modulated converted, i.e. reflected from a fiber fault). The second optical signals shown is generated by a passive modulation conversion from an example 1 Hz first optical signal of any type of modulation (e.g. wavelength or polarization). The first and second optical signals 235,236 are shown as a power variation with frequency. Power and intensity may be considered as corresponding characteristics. The intensity modulated second optical signal has the physical property of an intensity, whereas power, which corresponds to intensity, is the square of intensity, and is the physical property which is measured, e.g. by the photodiode.

The second optical signal 235 shows a power (corresponding to intensity) spectrum corresponding to the intensity modulation of the first optical signal, as shown in the example of FIG. 8. The power spectrum shows the spectral harmonics at multiples of the modulation frequency, i.e. 1 Hz in this example. The spectral harmonics shown in the power spectrum may be used to identify the presence of an intensity modulated second optical signal, indicative of no fault between the main unit and remote unit when the intensity modulated second optical signal is present.

Detected power levels corresponding to the power spectrum may be used by the detector and/or controller, and used to determined that the second optical signal 235 has been received. The detector and/or controller may be configured to detect the fault by comparing a filtered portion of the power spectrum with a threshold value. The filter can be implemented in a digital domain, e.g. using a digital signal processor. For example, the second optical signal is determined to be detected when a comparison indicates the received optical signal comprises intensity peaks, of an absolute value or relative to other received values, due to the intensity modulation exceed a threshold.

In some examples, the detector and/or controller is configured to detect the presence of power (i.e. intensity) variations in the received optical signal, i.e. identifying periodic variations with time in the received optical signal, to identify the second optical signal. The periodic variations correspond to the periodicity of the first optical signal, e.g. same period or half the period.

These examples of analyzing the received optical signal to determine a presence (or absence) of the second optical signals may be considered as identifying periodic variations in the received signal, e.g. in a frequency or time domain. In the example shown of the second optical signal 225, there is no fault in the optical communications network 30 between the main unit and remote unit.

By contrast, the received optical signal 226 does not show any spectral harmonics or intensity variation over time corresponding to the intensity modulation expected of the second optical signal. Thus, the optical signal 226 corresponds to the back-scattered first optical signal. This indicates a fault in the optical communications network 30 between the main unit and remote unit, which causes reflection (or absorption) of the first optical signal prior to its passive modulation conversion to the second optical signal.

Examples of the disclosure include that the detector is configured to identify a presence of the second optical signal to detect a fault in the optical communication network. This may be considered as the detector is configured to identify whether the second optical signal is present or absent in the received optical signal. As described above, a determination that the second optical signal is present indicates there is no fault in the optical communication network, and/or, a determination that the second optical signal is absent (i.e. not present) indicates there is a fault in the optical communication network. The detector may be configured to determine either one or both of whether the second optical signal is present or absent in a received optical signal.

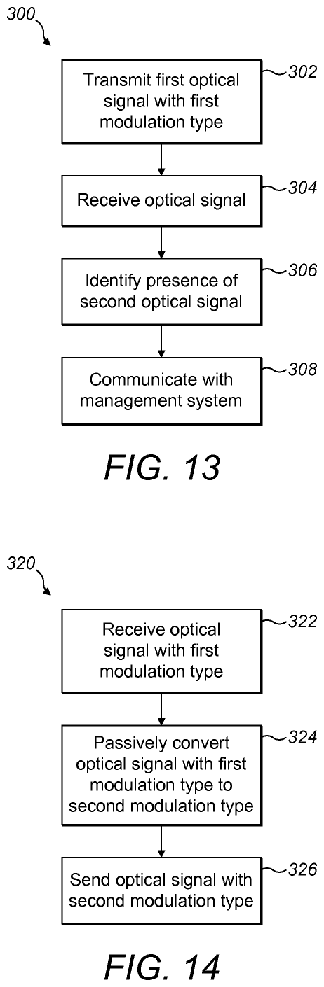

FIG. 13 shows an example method 300 in a main unit for detecting a fault in the optical communication network according to an example of the disclosure.

The method comprises, in 302, the main unit transmitting a first optical signal from the main unit on the optical communication network. The first optical signal has a first modulation type, e.g. wavelength or polarization modulation.

In 304, the main unit receives from the remote unit an optical signal. The main unit is configured to receive an optical signal which has a second modulation type on the optical communication network, wherein the second modulation type is different to the first modulation type, and

In step, 306, the method comprises identifying a presence of the second optical signal to detect a fault in the optical communication network. The identifying a presence of the second optical signal comprises identifying whether the second optical signal is present or absent. As described above, an identification that the second optical signal is absent indicates that there is a fault in the optical communication network between the main unit and remote unit.

Optionally in 308, the main unit communicates, e.g. with a management system, that a fault and/or no fault exists in the optical communication network between the main unit and remote unit.

FIG. 14 shows an example method 320 in a remote unit for detecting a fault in the optical communication network according to an example of the disclosure.

The method comprises, in the remote unit, receiving 322 the first optical signal from the main unit. This method 320 assumes that there is no fault in the optical communications network, to allow the first optical signal to reach the remote unit.

The method comprises, in the remote unit, modulation converting 324 a first optical signal received from the main unit on the optical communication network, wherein the first optical signal has a first modulation type. The modulation converter converts the first optical signal having the first modulation type to a second optical signal having a second modulation type. The second modulation type is different to the first modulation type. The modulation converting uses a passive device, e.g. filter or polarizer, as described above.

The method further comprises, sending 326 the second optical signal having the second modulation type to the main unit using the optical communication network. For example, the remote unit reflects the first or second optical signal, e.g. using a reflector or reflecting passive component.

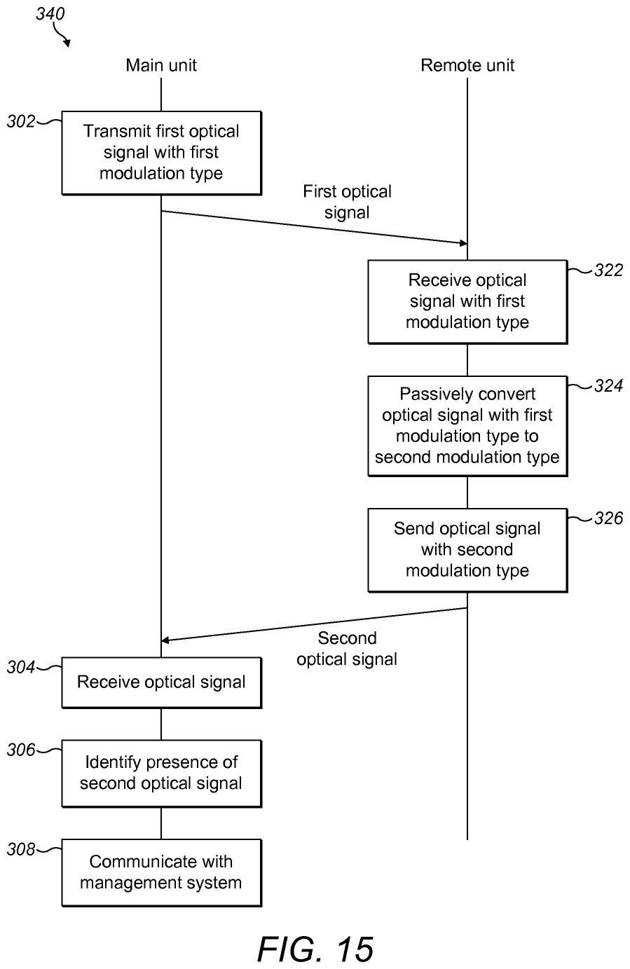

FIG. 15 shows a signalling diagram 340 for the main unit 10 and remote unit 20. The features described are as described above, and corresponding reference numerals are used. The process as shown starts with the transmission 302 of the first optical signal to the remote unit 20. The remote unit receives 322 the first optical signal, passively converts 324 the modulation of the first optical signal to generate the second optical signal, and sends 326 (e.g. by reflection) the second optical signal back to the main unit. At the main unit, an optical signal is received 304, and the main unit determines 306 the presence of the second optical signal (i.e. present or absent). Optionally, the status of the optical communication network (e.g. detected fault or no detected fault) is transmitted to an external or internal system, e.g. management system.

Aspects of the present disclosure provide a semi-passive fronthaul system including an active monitoring subsystem at the main site and a passive demarcation element at the remote site, as described.

At the remote site, a passive device is responsible to convert the received modulated signal (i.e. first optical signal) to an intensity modulated signal (i.e. second optical signal) by applying, for example, a passive wavelength-to-intensity or polarization-to-intensity conversion. The converted probing signal is reflected to the main site by a reflector, where the intensity modulation is detected by a low frequency tone detector.

A fault condition in the optical communications network 30 is determined by detecting the loss of signal on the received intensity modulation: if the fiber is broken the probing signal (i.e. first optical signal) does not reach the passive converter at the remote end and no conversion to intensity modulation occurs. The detection can be simply based on a threshold setting on the modulation amplitude received.

Given that the modulation conversion occurs at the remote demarcation point, the principle is compatible with single fiber bidirectional operation. In fact, in case of fiber fault, the reflected power (i.e. of the first optical signal) at the fiber-to-air interface does not carry the amplitude modulation which is introduced only if the fiber continuity is verified down to the demarcation point.

The described method does not use power generated by the remote transceivers so the demarcation point is defined by the reflector itself.

### Abbreviations

| Abbreviation | Explanation |
|---|---|
| BBU | Base Band Unit |
| CPRI | Common Radio Interface |
| CRAN | Centralized (cloud, coordinated) Radio Access Network |
| MTTR | Mean Time To Repair |
| NMS | Network Management System |
| OOB | Out of Band |
| OSC | Optical Supervisory Channel |
| OTDR | Optical Time Domain Reflectometer |
| RRU | Remote Radio Unit |
| WDM | Wavelength Division Multiplexing |

1-23. (canceled)

24. A remote unit for communication with a main unit in an optical communication network, wherein the main unit and the remote unit are configured to detect a fault in the optical communication network, the remote unit comprising:
a modulation converter configured to receive a first optical signal from the main unit on the optical communication network, wherein the first optical signal has a first modulation type;
wherein the modulation converter is configured to convert the first optical signal having the first modulation type to a second optical signal having a second modulation type, wherein the second modulation type is different to the first modulation type;
wherein the modulation converter is a passive device; and
wherein the remote unit is configured to send the second optical signal having the second modulation type to the main unit using the optical communication network.

25. The remote unit of claim 24, wherein the modulation converter has a transfer function configured such that the variations of the first optical signal corresponding to the first modulation type correspond to variations in the second modulation type.

26. The remote unit of claim 25, wherein the transfer function continuously varies in a range of the first modulation type of the first optical signal.

27. The remote unit of claim 24:
wherein the modulation converter is a filter configured to modulation convert the first optical signal, and wherein the first modulation type is a wavelength modulation; or
wherein the modulation converter is a polarizer configured to modulation convert the first optical signal, and wherein the first modulation type is a polarization modulation.

28. The remote unit of claim 24, further comprising a reflector configured to reflect the first or second optical signal towards the main unit.

29. The remote unit of claim 24, wherein the remote unit is configured to pass optical frequencies outside of a band of the first and second optical signals.

30. The remote unit of claim 24:
wherein the first modulation type is a wavelength modulation or a polarization modulation; and
wherein the second modulation type is an intensity modulation.

31. A main unit for communication with a remote unit in an optical communication network, wherein the main unit and the remote unit are configured to detect a fault in the optical communication network, the main unit comprising:
processing circuitry; and
memory containing instructions executable by the processing circuitry whereby the main unit is operative to:
transmit a first optical signal from the main unit on the optical communication network, wherein the first optical signal has a first modulation type;
receive an optical signal from the remote unit; and
identify a presence of a second optical signal in the received optical signal to detect a fault in the optical communication network; the second optical signal having a second modulation type on the optical communication network, wherein the second modulation type is different to the first modulation type.

32. The main unit of claim 31, wherein the instructions are such that the main unit is operative to identify periodic variations in the second optical signal corresponding to the second modulation type.

33. The main unit of claim 31, wherein the first modulation type is a wavelength modulation or a polarization modulation.

34. The main unit of claim 31, wherein the second modulation type is an intensity modulation.

35. The main unit of claim 31, wherein the optical communication network is a single bidirectional optical fiber connecting the main unit and remote unit.

36. The main unit of claim 31, wherein the remote unit is connected to a remote radio unit and/or the main unit is connected to a baseband processing unit.

37. The main unit of claim 31, wherein the first and second optical signals are in a frequency range which is out of band of data transmitted on the optical communications network.

38. A method, in a remote unit, for communicating with a main unit in an optical communication network, wherein the main unit and remote unit are configured for detecting a fault in the optical communication network, the method comprising the remote unit:
modulation converting a first optical signal received from the main unit on the optical communication network, wherein the first optical signal has a first modulation type; wherein the modulation conversion converts the first optical signal having the first modulation type to a second optical signal having a second modulation type, wherein the second modulation type is different to the first modulation type; wherein the modulation converting uses a passive device; and
sending the second optical signal having the second modulation type to the main unit using the optical communication network.

39. The method of claim 38:
wherein the modulation converting is by a filter configured to modulation convert the first optical signal, and wherein the first modulation type is a wavelength modulation; or
wherein the modulation converting is by a polarizer configured to modulation convert the first optical signal, and wherein the first modulation type is a polarization modulation.

40. The method of claim 38, further comprising reflecting the first or second optical signal towards the main unit.

41. A method in a main unit for communicating with a remote unit in an optical communication network, wherein the main unit and remote unit are configured for detecting a fault in the optical communication network, the method comprising the main unit:
transmitting a first optical signal from the main unit on the optical communication network, wherein the first optical signal has a first modulation type;
receiving an optical signal from the remote unit; and
identifying a presence of a second optical signal in the received optical signal to detect a fault in the optical communication network; the second optical signal having a second modulation type on the optical communication network, wherein the second modulation type is different to the first modulation type.

42. The method of claim 41, wherein the identifying the presence of the second optical signal comprises identifying periodic variations in the second optical signal corresponding to the second modulation type.

43. The method of claim 41:
wherein the first modulation type is a wavelength modulation or a polarization modulation; and/or
wherein the second modulation type is an intensity modulation.
